(19) United States
(12) Patent Application Publication
(10) Pub. No.: US 2023/0404081 A1
(43) Pub. Date: Dec. 21, 2023

(54) A FORMULATION AND A METHOD FOR INDUCING DEFENSE RESPONSE IN PLANTS

(71) Applicant: NATIONAL INSTITUTE OF PLANT GENOME RESEARCH, New Delhi (IN)

(72) Inventors: Pradeep Kumar PATHAK, New Delhi (IN); Sudhir H RANGANATH, Karnataka (IN); Girigowda MANJUNATHA, Karnataka (IN); Kapuganti Jagadis GUPTA, New Delhi (IN)

(21) Appl. No.: 18/252,017

(22) PCT Filed: Nov. 8, 2021
(86) PCT No.: PCT/IN2021/051056

§ 371 Date: May 5, 2023

(30) Foreign Application Priority Data
Nov. 7, 2020 (IN) 202011019481

(51) Int. Cl. A01N 59/02; A01N 25/28; A01N 65/03; A01P 15/00

(52) U.S. Cl. CPC A01N 59/02; A01N 25/28; A01N 65/03; A01P 15/00

(57) ABSTRACT

The present disclosure relates to a nanoparticle formulation comprising sodium dithionite and at least one nitrite. The present disclosure also relates to a method for treating a plant to induce defense responses, said method comprising: applying sodium dithionite or a substrate comprising the sodium dithionite to a part of a plant for treating the plant to induce defense responses. Also, disclosed herein is a method of preparing the nanoparticle formulation.

### FIELD OF INVENTION

The present disclosure broadly relates to the field of plant biology, in particular the present disclosure discloses a nanoparticle formulation, a method to induce plant defense response. The present disclosure also discloses a method of preparing the nanoparticle formulation as described herein.

### BACKGROUND OF THE INVENTION

Plants often encounter challenges from a wide variety of pathogens. In response to pathogen attack, plants have developed various array of defense mechanisms such as release of various hormones including salicylic acid, jasmonic acid, ethylene and free radicals such as ROS and NO to develop plant resistance via signalling cascade in various crops (Dow et al., 2000; Annu Rev Phytopathol, 38, 241-261). There are numerous reports available in literature that treatment of plants with beneficial microbes or certain chemicals can elicit plant defense responses (Conrath 2009; Adv Bot Res, 51, 361-395). For instance, pre-treatment of these elicitor molecules or chemicals cause priming effect which is considered as a state where plant defense responses are activated leading to enhanced defense when challenged with pathogens (Mauch-Mani et al 2017; Annu Rev Plant Biol, 68, 485-512). Plants have various receptors to recognise pathogen-associated molecular patterns (PAMPs), damage-associated molecular patterns (DAMPs) or elicitor molecules which trigger PAMP-triggered immunity and effector-triggered immunity, respectively. Upon recognition, plants activate signal cascade leading to induction of genes which are important for plant defense response. Depending on the pathogen, these responses are activated locally and also systemically. Several lines of research suggest that lipopolysaccharides and flagellin from certain bacteria, chitin and B-glucans from certain fungus can act as elicitors in plant defense responses, these molecules also important for priming the defense responses (Boller 2009, Annu Rev Plant Biol, 60, 379-406; Thomma et al 2011, Plant Cell 23, 4-15; Flury et al., 2013, Plant Physiol, 161, 2023-2035). If these defense responses are present in beneficial microbes, these are called as microbe-associated molecular pattern (MAMP) (Pieterse 2014; Annu. Rev. Phytopathol, 52, 347-375). Plant growth promoting rhizo bacteria and fungus (PGPR & PGPF) are known to induce plant defense responses.

Several chemicals and elicitor molecules were used to induce plant defense responses. For instance, Sathiyabama & Manikandan 2016 used Chitosan nanoparticles to induce defense responses against Pyricularia grisea in fingermillet plants. The application of copper-chitosan nanoparticle (CuChNp) have increased the yield of finger millet plants by nearly 89% and reduced the blast disease (Pyricularia grisea) by nearly 75% via increasing expression of defense enzymes (Sathiyabama & Manikandan, 2018; Journal of agricultural and food chemistry, 66, 1784-1790).

Since plant defense system is a complex system which is intertwined with plant metabolic pathways, the methods available in the prior arts have tested varied success in inducing plant defense system against an array of plant pathogens, therefore, there still exists a need in the art to arrive at an effective method for protecting plants from the attack of the pathogens.

### SUMMARY OF INVENTION

In an aspect of the present disclosure, there is provided a nanoparticle formulation comprising sodium dithionite and at least one nitrite.

In another aspect of the present disclosure, there is provided a method for treating a plant to induce defense responses, said method comprising: applying sodium dithionite to a part of a plant for treating the plant to induce defense responses.

In another aspect of the present disclosure, there is provided a method for treating a plant to induce defense responses, said method comprising: applying a substrate comprising sodium dithionite to a part of a plant for treating the plant to induce defense responses.

In another aspect of the present disclosure, there is provided a method for treating a plant to induce defense responses, said method comprising: (a) coating a substrate with a composition comprising sodium dithionite, to obtain sodium dithionite coated-substrate; and (b) treating a part of a plant with the sodium dithionite coated-substrate, wherein the treating leads to induction of defense responses.

In another aspect of the present disclosure, there is provided a method for obtaining nanoparticle formulation as described herein, said method comprising: (a) obtaining sodium dithionite; (b) adding sodium dithionite to at least one vehicle to obtain a first mixture; (c) contacting the first mixture and at least one surfactant to obtain a second mixture; (d) adding at least one solvent to the second mixture to obtain a third mixture, followed by emulsifying the third mixture to obtain an emulsified mixture; (e) adding a solution of nanoparticles drop-wise to the emulsified mixture to obtain a crosslinked nanoparticle, wherein the nanoparticles are selected from the group consisting of calcium alginate nanoparticles, barium alginate nanoparticle, and strontium alginate nanoparticles; and (f) processing the crosslinked nanoparticle to obtain a nanoparticle formulation.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF ACCOMPANYING DRAWINGS

The following drawings form a part of the present specification and are included to further illustrate aspects of the present disclosure. The disclosure may be better understood by reference to the drawings in combination with the detailed description of the specific embodiments presented herein.

FIG. 1 A depicts the preparation of sodium dithionite coated brown mustard seeds, and FIG. 1 B depicts the placement of the coated mustard seeds on pomegranate leaves, in accordance with an embodiment of the present disclosure.

FIG. 2 depicts the control and treated plants challenged by spraying XAP (Xanthomonas axonopodis pv. Punicae) culture, in accordance with an embodiment of the present disclosure.

FIG. 3 depicts the development of disease symptoms in control infected and sodium dithionite pre-treated local and distal (distal leaves from same plants treated with sodium dithionite locally), in accordance with an embodiment of the present disclosure.

FIG. 4 depicts the coating of Whatman filter paper with sodium dithionite and the leaves placed with the treated Whatman filter paper, in accordance with an embodiment of the present disclosure.

FIG. 5 depicts sodium dithionite coated stickers attached to tomato leaves, in accordance with an embodiment of the present disclosure.

FIG. 6 depicts the hyper-responsive symptoms appearing 3 hours post treatment with sodium dithionite, in accordance with an embodiment of the present disclosure.

FIG. 7 depicts nitric oxide (NO) estimation from sodium dithionite stickers and sodium dithionite in water treated plants by using DAF-FM dye after 3 h of post treatment, in accordance with an embodiment of the present disclosure.

FIG. 8 A depicts the salicylic acid levels in the distal leaves of treated plants and FIG. 8 B depicts the bacterial growth in response to the treatment, in accordance with an embodiment of the present disclosure.

FIG. 9A depicts representative images of virulent P. syringae DC 3000 infection from the control and sodium dithionite nanoparticles treated plants, in accordance with an embodiment of the present disclosure.

FIG. 9B depicts representative images of Xanthomonas axonopodis pv. punicae (XAP) infection to the control and sodium dithionite nanoparticles treated pomegranate plants, in accordance with an embodiment of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “substrate” refers to any inert material which is being used as a vehicle for contacting a composition comprising sodium dithionite to a plant. The present disclosure encompasses the use of any inert material as the substrate.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

As discussed in the background section of the present disclosure, there is a need in the art to strategize an effective method for protecting plants from various pathogens. Hence, to address the existing problems in the art, the present disclosure provides an effective solution in inducing defense response in plants by treating a part of the plant by sodium dithionite. The present disclosure discloses that the plant treated with sodium dithionite or a combination of sodium dithionite and at least one nitrite effectively induces defense system in the plant. For this purpose, the present disclosure discloses a nanoparticle formulation comprising sodium dithionite and at least one nitrite, that is applied to a part of the plant for inducing defence response in plants. The present disclosure discloses that such a treatment effectively treats the plant from the pathogen attack. The present disclosure discloses that the plant treated with a substrate which is coated with a combination of sodium dithionite and at least one nitrite effectively induces the defense system of the plant. Further, a method for inducing defense response in the plant is provided in which a part of the plant is treated with the nanoparticle formulation as provided herein. The treatment as disclosed herein induces NO production which increases plant defense via generation of defense related compounds such as salicylic acid. The present disclosure also discloses an effective method for obtaining the nanoparticle formulation.

In an embodiment of the present disclosure, there is provided a nanoparticle formulation comprising sodium dithionite and at least one nitrite.

In an embodiment of the present disclosure, there is provided a nanoparticle formulation comprising sodium dithionite, wherein the nanoparticle induces defense response in plants.

In an embodiment of the present disclosure, there is provided a nanoparticle formulation comprising sodium dithionite and at least one nitrite, wherein the at least one nitrite is selected from the group consisting of potassium nitrite, sodium nitrite, and calcium nitrite. In another embodiment, the at least one nitrite is potassium nitrite.

In an embodiment of the present disclosure, there is provided a nanoparticle formulation comprising sodium dithionite and at least one nitrite, wherein the formulation comprises calcium alginate nanoparticles.

In an embodiment of the present disclosure, there is provided a nanoparticle formulation comprising sodium dithionite and at least one nitrite, wherein the formulation comprises barium alginate nanoparticles.

In an embodiment of the present disclosure, there is provided a nanoparticle formulation comprising sodium dithionite and at least one nitrite, wherein the formulation comprises strontium alginate nanoparticles.

In an embodiment of the present disclosure, there is provided a nanoparticle formulation comprising sodium dithionite and at least one nitrite, wherein the formulation comprises at least one coating agent, and wherein the at least one coating agent is selected from the group consisting of maltodextrin, trehalose, and dextrose.

In an embodiment of the present disclosure, there is provided a nanoparticle formulation comprising sodium dithionite and at least one nitrite, wherein the formulation comprises at least one coating agent, and wherein the at least one coating agent is maltodextrin.

In an embodiment of the present disclosure, there is provided a nanoparticle formulation comprising sodium dithionite and at least one nitrite, wherein the formulation comprises at least one coating agent, and wherein the formulation comprises sodium dithionite and at least one nitrite in a weight ratio range of 10:1 to 1:1. In another embodiment of the present disclosure, the sodium dithionite and at least one nitrite is present in a weight ratio range of 9:1 to 1:1, 7:1 to 1:1, or 6:1 to 1:1.

In an embodiment of the present disclosure, there is provided a method for treating a plant to induce defense responses, said method comprising: applying sodium dithionite to a part of a plant for treating the plant to induce defense responses.

In an embodiment of the present disclosure, there is provided a method for treating a plant to induce defense responses, said method comprising: applying a substrate comprising sodium dithionite to a part of a plant for treating the plant to induce defense responses.

In an embodiment of the present disclosure, there is provided a method for treating a plant to induce defense responses as described herein, wherein sodium dithionite is applied in form of nanoparticles.

In an embodiment of the present disclosure, there is provided a method for treating a plant to induce defense responses as described herein, wherein applying sodium dithionite is carried out for a time-period in a range of 1 to 6 hours.

In an embodiment of the present disclosure, there is provided a method for treating a plant to induce defense responses as described herein, wherein the part of the plant is selected from a group consisting of leaves, stem, fruit, and flowers.

In an embodiment of the present disclosure, there is provided a method for treating a plant to induce defense responses as described herein, wherein sodium dithionite is applied to the part of the plant using a substrate.

In an embodiment of the present disclosure, there is provided a method for treating a plant to induce defense responses as described herein, wherein sodium dithionite is applied to the part of the plant using a substrate, and wherein the substrate is selected from a group consisting of paper, glass beads, and silica beads.

In an embodiment of the present disclosure, there is provided a method for treating a plant to induce defense responses, said method comprising: (a) coating a substrate with a composition comprising sodium dithionite, to obtain sodium dithionite coated-substrate; and (b) treating a part of a plant with the sodium dithionite coated-substrate, wherein the treating leads to induction of defense responses. In another embodiment, treating can be done by spraying or dipping.

In an embodiment of the present disclosure, there is provided a method for treating a plant to induce defense responses, said method comprising: (a) coating a substrate with a composition comprising sodium dithionite, to obtain sodium dithionite coated-substrate; and (b) treating a part of a plant with the sodium dithionite coated-substrate, wherein the treating leads to induction of defense responses, and wherein the composition comprises sodium dithionite and at least one nitrite. In another embodiment, the at least one nitrite is potassium nitrite.

In an embodiment of the present disclosure, there is provided a method for treating a plant to induce defense responses, said method comprising: (a) coating a seed material with a composition comprising sodium dithionite, to obtain sodium dithionite coated-seed material; and (b) treating a part of a plant with the sodium dithionite coated-seed material, wherein the treating leads to induction of defense responses, and wherein the substrate is selected from a group consisting of seed, paper, glass beads, and silica beads. In another embodiment, the substrate is mustard seeds.

In an embodiment of the present disclosure, there is provided a method for treating a plant to induce defense responses, said method comprising: (a) coating a substrate with a composition comprising sodium dithionite, to obtain sodium dithionite coated-substrate; and (b) treating a part of a plant with the sodium dithionite coated-substrate, wherein the treating leads to induction of defense responses, and wherein coating the substrate with sodium dithionite is carried out by mixing the substrate with sodium dithionite in the presence of at least one solvent.

In an embodiment of the present disclosure, there is provided a method for treating a plant to induce defense responses, said method comprising: (a) coating a substrate with a composition comprising sodium dithionite, to obtain sodium dithionite coated-substrate; and (b) treating a part of a plant with the sodium dithionite coated-substrate, wherein the treating leads to induction of defense responses.

In an embodiment of the present disclosure, there is provided a method for treating a plant to induce defense responses, said method comprising: (a) obtaining a nanoparticle formulation comprising sodium dithionite and at least one nitrite; and (b) treating a part of a plant with the nanoparticle formulation, wherein the treating leads to induction of defense responses.

In an embodiment of the present disclosure, there is provided a method for treating a plant to induce defense responses, said method comprising: (a) obtaining a nanoparticle formulation comprising sodium dithionite and at least one nitrite; and (b) treating a part of a plant with the nanoparticle formulation, wherein the treating leads to induction of defense responses, and wherein the at least one nitrite is potassium nitrite.

In an embodiment of the present disclosure, there is provided a method for treating a plant to induce defense responses, said method comprising: (a) obtaining a nanoparticle formulation comprising sodium dithionite and at least one nitrite; and (b) treating a part of a plant with the nanoparticle formulation, wherein the treating leads to induction of defense responses, and wherein the formulation comprises calcium alginate nanoparticles.

In an embodiment of the present disclosure, there is provided a method for treating a plant to induce defense responses, said method comprising: (a) obtaining a nanoparticle formulation comprising sodium dithionite and at least one nitrite; and (b) treating a part of a plant with the nanoparticle formulation, wherein the treating leads to induction of defense responses, and wherein the formulation comprises at least one coating agent. In another embodiment, the coating agent is maltodextrin.

In an embodiment of the present disclosure, there is provided a method for treating a plant to induce defense responses, said method comprising: (a) obtaining a nanoparticle formulation comprising sodium dithionite and at least one nitrite in a weight ratio range of 10:1 to 1:1; and (b) treating a part of a plant with the nanoparticle formulation, wherein the treating leads to induction of defense responses.

In an embodiment of the present disclosure, there is provided a method for treating a plant to induce defense responses, said method comprising: (a) obtaining a nanoparticle formulation comprising sodium dithionite and at least one nitrite; and (b) treating a part of a plant with the nanoparticle formulation, wherein the treating leads to induction of defense responses, and wherein the part of the plant is selected from a group consisting of leaves, stem, fruit, and flowers.

In an embodiment of the present disclosure, there is provided a method for treating a plant to induce defense responses as described herein, wherein the method leads to reduction in pathogen infection in the plant.

embodiment of the present disclosure, there is provided a method for treating a plant to induce defense responses as described herein, wherein the plant is either a monocot or a dicot.

In an embodiment of the present disclosure, there is provided a method for obtaining nanoparticle formulation as described herein, said method comprising: (a) obtaining sodium dithionite; (b) adding sodium dithionite to at least one vehicle to obtain a first mixture; (c) contacting the first mixture and at least one surfactant to obtain a second mixture; (d) adding at least one solvent to the second mixture to obtain a third mixture, followed by emulsifying the third mixture to obtain an emulsified mixture; (e) adding a solution of nanoparticles drop-wise to the emulsified mixture to obtain a crosslinked nanoparticle, wherein the nanoparticles are selected from the group consisting of calcium alginate nanoparticles, barium alginate nanoparticle, and strontium alginate nanoparticles; and (f) processing the crosslinked nanoparticle to obtain a nanoparticle formulation.

In an embodiment of the present disclosure, there is provided a method for obtaining nanoparticle formulation as described herein, said method comprising: (a) obtaining sodium dithionite; (b) adding sodium dithionite to at least one vehicle to obtain a first mixture, followed by adding nitrite to the first mixture; (c) contacting the first mixture and at least one surfactant to obtain a second mixture; (d) adding at least one solvent to the second mixture to obtain a third mixture, followed by emulsifying the third mixture to obtain an emulsified mixture; (e) adding a solution of nanoparticles drop-wise to the emulsified mixture to obtain a crosslinked nanoparticle, wherein the nanoparticles are selected from the group consisting of calcium alginate nanoparticles, barium alginate nanoparticle, and strontium alginate nanoparticles; and (f) processing the crosslinked nanoparticle to obtain a nanoparticle formulation.

In an embodiment of the present disclosure, there is provided a method for obtaining nanoparticle formulation as described herein, said method comprising: (a) obtaining sodium dithionite; (b) adding sodium dithionite to at least one vehicle to obtain a first mixture, followed by adding alginate solution to the first mixture; (c) mixing the first mixture and at least one surfactant to obtain a second mixture; (d) adding at least one solvent to the second mixture to obtain a third mixture, followed by emulsifying the third mixture to obtain an emulsified mixture; (e) adding a solution of nanoparticles drop-wise to the emulsified mixture to obtain a crosslinked nanoparticle, wherein the nanoparticles are selected from the group consisting of calcium alginate nanoparticles, barium alginate nanoparticle, and strontium alginate nanoparticles; and (f) processing the crosslinked nanoparticle to obtain a nanoparticle formulation, and wherein the method further comprises coating the nanoparticle formulation with at least one coating agent.

In an embodiment of the present disclosure, there is provided a method for obtaining nanoparticle formulation as described herein, wherein the vehicle is water, and wherein the solvent is acetone, and wherein the surfactant is polysorbate 80.

In an embodiment of the present disclosure, there is provided a method for obtaining nanoparticle formulation as described herein, wherein contacting the first mixture and at least one surfactant is done at a speed in the range of 500-600 rpm, and wherein emulsifying the third mixture is done by using ultra sonification to obtain the emulsified mixture, and wherein adding the solution of nanoparticles drop-wise at a speed in the range of 850-1000 rpm to the emulsified mixture, and wherein processing the crosslinked nanoparticle is done at a speed in the range of 10,000-12,000 rpm.

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may vary.

The present section highlights the various results for describing the present disclosure.

### Example 1

### Treatment with Mustard Seeds Coated with Sodium Dithionite for Inducing Plant Defense Response

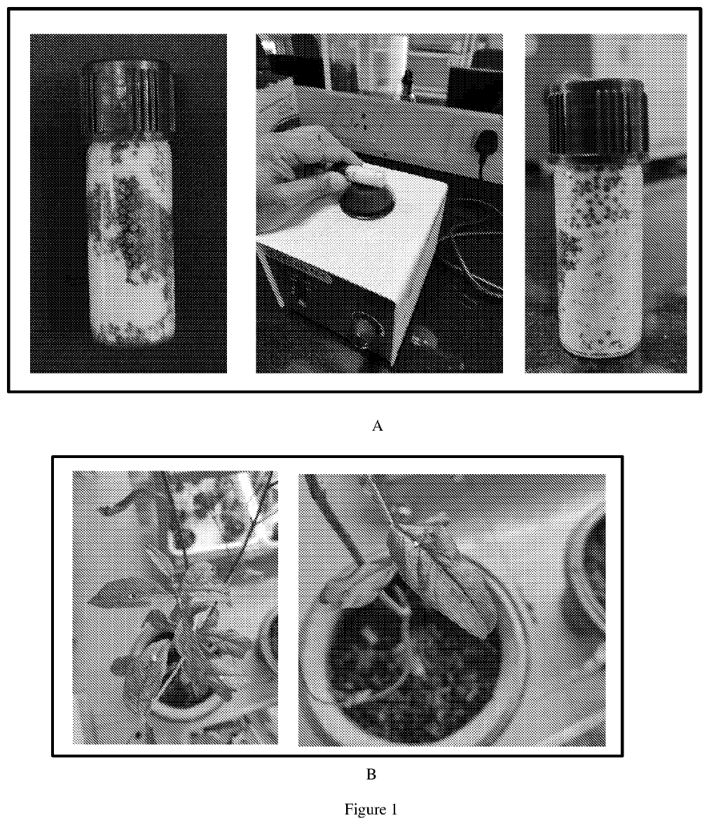

Mustard seeds (Brassica juncea seeds) were purchased from a local market in New Delhi. Sodium dithionite (HiMedia Labs) was taken from container in an anoxic chamber (to avoid oxidation). Sodium dithionite was transferred into 5 ml tube with 2.5 g of glycerol-coated mustard seeds to obtain a mixture. The mixture was vortexed (FIG. 1A) for uniform distribution to obtain mustard seeds coated with sodium dithionite. To check whether the mustard seeds coated with sodium dithionite are able to induce the plant's innate immune responses, the coated seeds were contacted with the adaxial surface of pomegranate leaves (FIG. 1B).

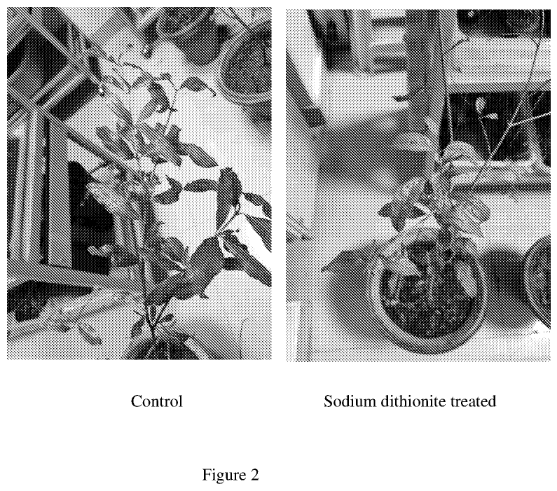

After a 3-hour post-treatment, pomegranate plants were challenged by spraying Xanthomonas axonopodis pv. Punicae (XAP) (2×10⁷ cfu ml⁻¹) (FIG. 2 showing control and treated plants). The strain XAP has accession number KX702398.1, and has its origin from Balgalkot, Karnataka, India. The appearance of disease symptoms was observed till 7 days' post-challenge. Plants not treated with the coated mustard seeds but challenged with XAP were considered as control. Infection was induced in pathogen infection room at 26±2° C. and 60-70% relative humidity.

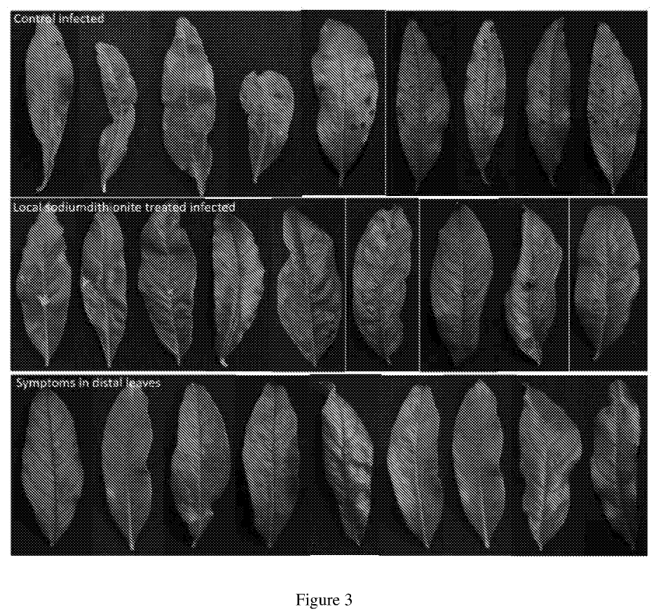

Results obtained—Symptoms of disease development were recorded after 7 days' post XAP spray. Leaves of pomegranate plants treated with sodium dithionite coated mustard seeds develop lesser disease symptoms. Distal leaves of respective coated mustard seeds-treated branches also show significantly less symptoms of disease as compared to the control plants. The treated leaves displayed the development of hyper sensitive response like symptoms instead of their characteristic bacterial spots (FIG. 3).

### Example 2

### Ability of Sodium Dithionite in Inducing Plant Defense Response

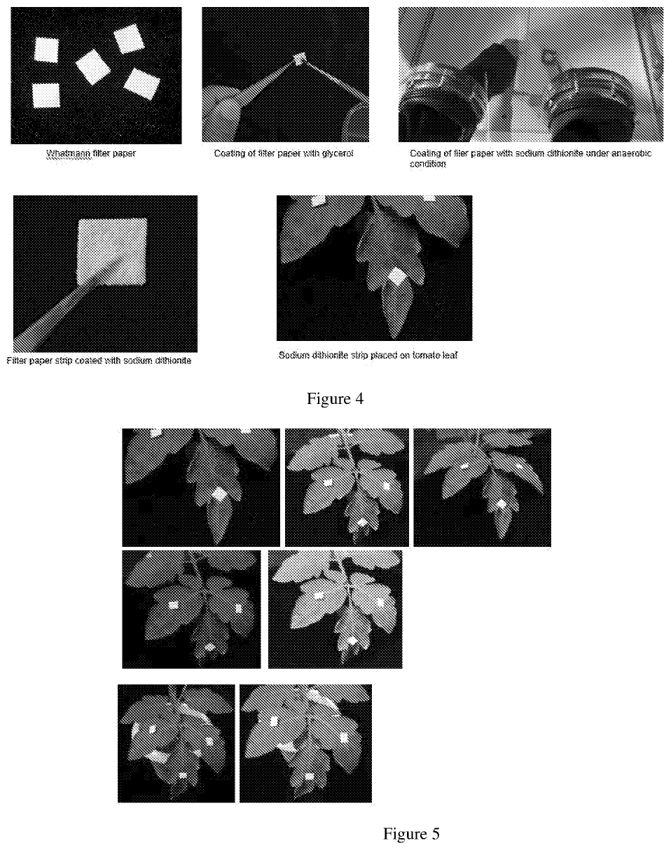

To check whether sodium dithionite is able to induce plants innate immune response, square stickers from Whatman filter papers were coated with sodium dithionite under anoxic conditions (FIG. 4). These stickers were stacked on the adaxial surface of tomato leaves for 3 hours (FIG. 5). The variety of the tomato plant used for the purposes of present disclosure is Pusa Rubi accessed from Indian Agricultural Research Institute, New Delhi, India.

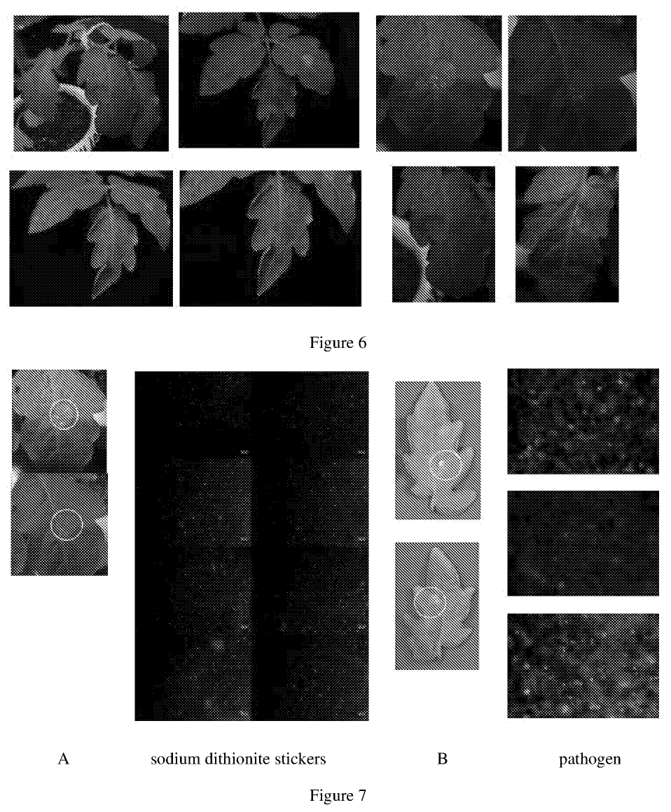

Results obtained—Hypersensitive response like symptoms started developing just after the treatment and was increased till 24 h post-sodium dithionite treatment (FIG. 6). Hypoxia condition can induce nitric oxide (NO) production which can induce defense responses. Hence, the production of NO in the leaves treated with sodium dithionite strips was observed using diaminofluorescein-FM diacetate (DAF-FM DA). Increased microbursts of NO in leaves treated with sodium dithionite treated leaves was observed (FIG. 7A).

Sodium dithionite-treated leaves were further treated with avirulent Pseudomonas syringae and the NO levels were checked. Larger spots representing bursts of NO were observed (FIG. 7B) suggesting a similar pattern of NO as the one which was inducible with sodium dithionite treatment alone.

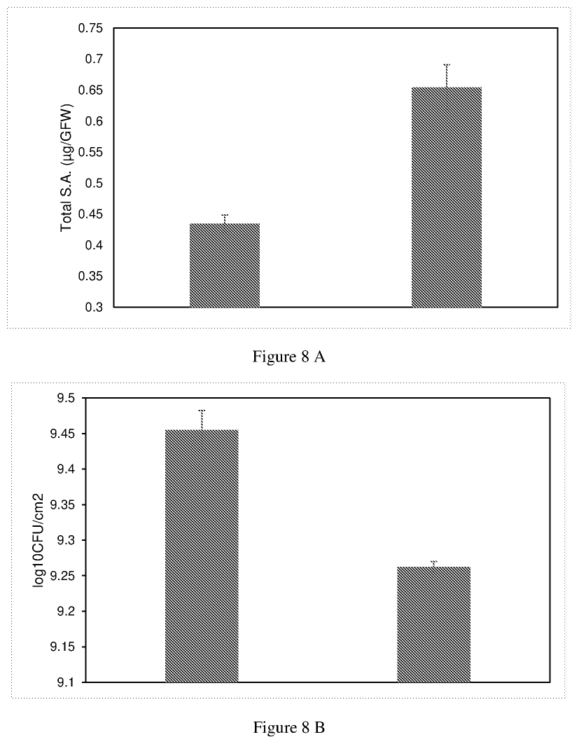

Since salicylic acid (SA) is important in the induction of systemic acquired resistance in plants, the distal leaf samples were collected for SA estimation at 6h post-sodium dithionite treatment. Results from SA estimation depicts that sodium dithionite is able to induce significant accumulation of SA in comparison to the control plants (FIG. 8). After observing higher SA accumulation in the distal parts of sodium dithionite treated plants, its efficiency against pathogen spread was checked. The sodium dithionite treated plants were challenged with Pseudomonas syringae pv. Tomato avrrpm1 DC3000 (1×10⁸ CFU/ml) to the distal part of the plants and observed phenotype of disease development till 48 hours post infection (hpi) (FIG. 8). Significant reduction in bacterial count was observed at 48 hpi in sodium dithionite treated plants in comparison to control plants challenged with P. syringae (FIG. 8). FIG. 8A depicts the SA levels from distal leaves in response to sodium dithionite treatment. FIG. 8B depicts the bacterial growth in response to sodium dithionite treatment.

### Example 3

### Nanoparticle Formulation Comprising Sodium Dithionite and Potassium Nitrite, and Method of Preparation Thereof

The present disclosure discloses the effect of sodium dithionite on inducing plant defense response. In order to show the effect of sodium dithionite in a nanoparticle formulation, a nanoparticle formulation is obtained as per the present Example.

The nanoparticle formulation as per the present disclosure is in form of sodium dithionite and potassium nitrite-loaded calcium alginate nanoparticles. The nanoparticles are further coated with maltodextrin to obtain maltodextrin coated sodium dithionite and potassium nitrite-loaded calcium alginate nanoparticles (nanoparticle formulation).

### Maltodextrin-Coated and Sodium Dithionite/KNO₂-Loaded Calcium Alginate Nanoparticles Prepared Via Nano-Emulsion Technique

Low viscosity (4-12 cP, 1% in H₂O at 25° C.) or medium viscosity (>2000 cP, 2% in H₂O at 25° C.) sodium alginate or potassium alginate with a molecular weight range of 50 to 200 kDa was dissolved in deionized and deoxygenated water to obtain 0.1 to 1% w/v by overnight stirring at room temperature. Separately, 10 g of anhydrous sodium dithionite and 0.1 g of potassium nitrite (HiMedia Labs) (10:0.1) were dissolved in deionized and deoxygenated water under inert atmosphere (inside a glove box in the presence of N₂ gas). The aqueous solutions were then mixed under inert atmosphere followed by the addition of 750 mg surfactant (Tween 80) to 100 mL of the aqueous solution. This mixture represents the water phase. Acetone was used as the organic phase, 5 mL of which was mixed with the aqueous phase. The mixture was then emulsified using ultrasonication with pulse mode (4 s on and 2 s off) for 10 min to form an oil in water (o/w) emulsion at room temperature. Calcium chloride solutions of varying concentrations (0.1 to 1% w/v) were separately prepared by dissolving it in deionized and deoxygenated water by stirring. The CaCl₂ solution was then added to the nano-emulsion using a syringe pump at flow rates of 0.1 to 1 mL/min, following which continuous ultrasonication was carried out at 42 W for 15 min to obtain calcium crosslinked alginate gel nanoparticles. To remove larger aggregates, impurities and unreacted alginate, the nanoparticle suspension was first centrifuged at 3000 rpm for 15 min. Large aggregates and impurities settled at the bottom were discarded. The supernatant containing the sodium dithionite/KNO₂-loaded calcium alginate nanoparticles was ultra-centrifuged at 20,000 rpm for about 20 min to collect the nanoparticles. The supernatant containing the surfactant and organic phase was removed. The nanoparticles were coated with 1% (w/v) maltodextrin (a food-grade sugar) to ensure protection of sodium dithionite from atmospheric oxygen. Since maltodextrin is water soluble, the layer would dissolve instantly when exposed to water. It is also used as a cryoprotectant here to protect the active ingredients inside the gel nanoparticles during freeze drying process. The maltodextrin coated nanoparticles were finally freeze dried for about 48 hours to remove water and dry powder of sodium dithionite/KNO₂-loaded calcium alginate nanoparticles coated with maltodextrin was obtained. The formulation was stored under anoxic and moisture free conditions.

### Calcium Alginate Microparticles Loaded with Sodium Dithionite/KNO₂ Powders Prepared Via Electrospray Technique

Medium viscosity (>2000 cP, 2% in H₂O at 25° C.) sodium alginate or potassium alginate was dissolved in deionized and deoxygenated water to obtain 2 to 4% w/v by overnight stirring at room temperature. 10 g of anhydrous sodium dithionite and 0.1 g of potassium nitrite were dispersed in the alginate solution under inert atmosphere. Calcium chloride solutions of varying concentrations (4 to 8% w/v) were separately prepared by dissolving it in deionized and deoxygenated water by stirring. Sodium dithionite/KNO₂-dispersed sodium alginate solution was then dripped into CaCl₂ solution at a rate of 1 to 5 mg/mL through a 21 G syringe. The syringe tip was connected to a high voltage. The CaCl₂ containing solution was placed at a distance of 15 cm below the needle tip and was connected to the ground. A potential difference between the needle tip and the collection vessel was maintained at about 10 to 20 kV. Due to the application of high voltage across the needle, a Taylor cone is formed, thus spraying the suspension giving rise to micron sized droplets. The droplets instantaneously gel in the presence of CaCl₂. The gelation was carried out for about 1 h to ensure complete crosslinking. This will protect sodium dithionite and KNO₂ to diffuse out of the gel microparticles. Immediately after gelation, the microparticles were collected via centrifugation at 2000 rpm for 10 min and coated with 1% (w/v) maltodextrin to protect the active ingredients from oxygen and moisture. Since maltodextrin is water soluble, the layer would dissolve instantly when exposed to water. It is also used as a cryoprotectant here to protect the active ingredients inside the gel microparticles during freeze drying process. The maltodextrin coated microparticles were finally freeze dried for about 48 hours to remove water and dry powder of sodium dithionite/KNO₂-loaded calcium alginate microparticles coated with maltodextrin was obtained. The formulation was stored under anoxic and moisture free conditions.

### Maltodextrin-Coated and Sodium Dithionite/KNO₂-Loaded Calcium Alginate Nanogels Prepared Via Template-Assisted Low-Energy Nano-Emulsion Technique

First, water-in-oil (W/O) nano-emulsion was synthesized by adding dispersed phase in a mixture of continuous phase and surfactant using decane as the oil. Tween 80 and Span 80 with HLB=7 formed the surfactant mixture. The emulsion was made by mixing the components added using a magnetic stirrer at approximately 800 rpm at 25° C. The rate of addition of the components was around 0.5 mL/min. The mixture was stirred for an additional 10 min at a constant speed after the addition of the components. The composition comprised 10 wt % aqueous phase, 10 wt % surfactant and 80 wt % decane. The aqueous phase was formed by 1.5 wt % alginate and Ca-EDTA complex (crosslinking precursor) along with desired concentration of sodium dithionite and KNO₂. The Ca-EDTA complex was prepared by reacting calcium chloride solution (50 mM) with disodium-EDTA solution (100 mM). To avoid pre-gelation of alginate aqueous phase due to calcium, disodium-EDTA was used in excess. To initiate gelation, acetic acid was added to the nano-emulsion. Acetic acid would dissociate Ca-EDTA complex and release divalent calcium ions. Ca²⁺ ions would then facilitate crosslinking of the aqueous alginate nanodroplets to yield the alginate nanoparticles containing sodium dithionite and KNO₂. The organic phase (decane) was later separated from the nanogel particles by centrifuging at 5000 rpm for about 20 min. The nanogel particles were then coated with 1% (w/v) maltodextrin to protect from oxygen. The coated nanogel particles were freeze dried for about 48 h and stored under anoxic and moisture-free conditions.

### Preparation of Na₂S₂O₄-Loaded Calcium Alginate Nanoparticles (NPs) Via Nano-Emulsion Technique

For the purpose of preparing the Na₂S₂O₄-loaded Calcium Alginate nanoparticles, following steps were performed:
(a) 400 mg of sodium alginate was dissolved in 100 mL of deionised and deoxygenated water (vehicle) by overnight (for 20-24 h) stirring (500-600 rpm) at room temperature (25±3° C.);
(b) 20 mg each of anhydrous sodium dithionite was dissolved in 100 mL of deionised and deoxygenated water under inert atmosphere in the presence of nitrogen gas;
(c) 750 mg of Tween 80 (surfactant), sodium dithionite solution (first mixture) were added to the sodium alginate solution and kept for stirring (500-600 rpm) for 30 min to obtain the aqueous phase (second mixture) with the emulsifier (Tween 80).
(d) To the third mixture, 5 mL of acetone (organic phase; solvent) was added and the resulting mixture was emulsified using ultra sonification for 10 min at RT (25±3° C.), to obtain an emulsified mixture.
(e) 5% w/v CaCl₂ solution (nanoparticle solution) was prepared separately by dissolving 2.5 g in 50 mL deionised and deoxygenated water at RT (25±3° C.)
(f) Next, the CaCl₂ solution was added to the emulsified mixture using a syringe dropwise under stirring at 850-1000 rpm to obtain calcium crosslinked alginate gel nanoparticles (crosslinked nanoparticle);
(g) To remove larger aggregates, impurities and unreacted alginate, the resultant mixture was first centrifuged at 3,000 rpm for 20 min, wherein larger aggregates and impurities settled at the bottom were discarded.
(h) The supernatant containing the Na₂S₂O₄-loaded Calcium alginate NPs was ultra-centrifuged at 11,000 rpm for about 20 min to collect the nanoparticles.
(i) The supernatant containing the surfactant and the organic phase was removed, the gel nanoparticles settled at the bottom were washed with 10 mL of acetone and air dried to obtain Na₂S₂O₄-loaded calcium alginate NPs powder (nanoparticle formulation of the present disclosure).

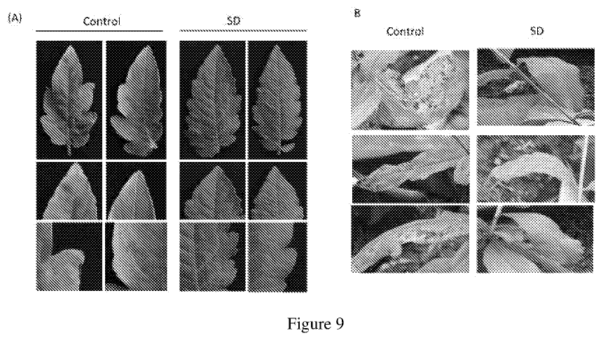

The experiments as listed in Example 2 were repeated using the nanoparticle formulation as disclosed in Example 3 and it was observed that the nanoparticle formulation was able to effectively induce the defense response in the plants. FIG. 9A discloses the effect of the nanoparticle formulation comprising Sodium dithionite to induce the defense response in the plants, wherein sodium dithionite nanoparticle formulation treated plants were further infected with virulent Pseudomonas syringae (10⁸ cfu/ml). Symptoms were observed at 4^{th} day post infection from control and sodium dithionite nanoparticle formulation treated plants. Similarly, sodium dithionite nanoparticle formulation treated pomegranate plants were infected with Xanthomonas axonopodis pv. punicae (XAP), as shown in FIG. 9B. It can be inferred from FIG. 9B that defense response against XAP were induced in nanoparticle formulation as compared to control plants.

Overall, the present disclosure discloses the ability of sodium dithionite to induce the plant defense responses. The application of sodium dithionite in the form of nanoparticle formulation creates hypoxia and leads to increase in the nitric oxide (NO) production which further leads to induction of salicylic acid (SA), thereby inducing the defense responses in plants.

### ADVANTAGES OF THE PRESENT DISCLOSURE

The present disclosure discloses a simple and efficient method for inducing plant defense responses. Further, a nanoparticle formulation is also disclosed which induces the defense response in plants in a robust manner. As per the method described herein, the plant provides an excellent response in terms of increasing the NO production and increasing the SA production which helps in treating the infections caused by pathogens in the plant.

1. A nanoparticle formulation comprising sodium dithionite and at least one nitrite.

2. The nanoparticle formulation as claimed in claim 1, wherein the at least one nitrite is selected from potassium nitrite, sodium nitrite, and calcium nitrite.

3. The nanoparticle formulation as claimed in claim 1, wherein the formulation comprises nanoparticles selected from the group consisting of calcium alginate nanoparticles, barium alginate nanoparticle, and strontium alginate nanoparticles.

4. The nanoparticle formulation as claimed in claim 1, wherein the formulation comprises at least one coating agent.

5. The nanoparticle formulation as claimed in claim 4, wherein the at least one coating agent is selected from the group consisting of maltodextrin, trehalose, and dextrose.

6. The nanoparticle formulation as claimed in claim 1, wherein the formulation comprises sodium dithionite and at least one nitrite in a weight ratio range of 10:1 to 1:1.

7. A method for treating a plant to induce defense responses, said method comprising: applying sodium dithionite to a part of a plant for treating the plant to induce defense responses.

8. (canceled)

9. The method for treating a plant as claimed in claim 7, wherein sodium dithionite is applied in form of a nanoparticles formulation comprising sodium dithionite and at least one nitrite.

10. The method for treating a plant as claimed in claim 7, wherein applying sodium dithionite is carried out for a time-period in a range of 1 to 6 hours.

11. The method for treating a plant as claimed in claim 7, wherein the part of the plant is selected from a group consisting of leaves, stem, fruit, and flowers.

12. The method for treating a plant as claimed in claim 7, wherein sodium dithionite is applied to the part of the plant using a substrate.

13. The method as claimed in claim 12, wherein the substrate is selected from a group consisting of seed, paper, glass beads, and silica beads.

14. The method for treating a plant as claimed in claim 7, wherein the part of the plant is selected from a group consisting of leaves, stem, fruit, and flowers.

15. The method for treating a plant as claimed in claim 7, wherein the method leads to reduction in pathogen infection in the plant.

16. A method for obtaining nanoparticle formulation as claimed in claim 1, said method comprising:
(a) obtaining sodium dithionite;
(b) adding sodium dithionite to at least one vehicle to obtain a first mixture;
(c) contacting the first mixture and at least one surfactant to obtain a second mixture;
(d) adding at least one solvent to the second mixture to obtain a third mixture, followed by emulsifying the third mixture to obtain an emulsified mixture;
(e) adding a solution of nanoparticles drop-wise to the emulsified mixture to obtain a crosslinked nanoparticle, wherein the nanoparticles are selected from the group consisting of calcium alginate nanoparticles, barium alginate nanoparticle, and strontium alginate nanoparticles; and
(f) processing the crosslinked nanoparticle to obtain a nanoparticle formulation.

17. The method as claimed in claim 16, further comprising adding nitrite to the first mixture.

18. The method as claimed in claim 16, further comprising adding an alginate solution to the first mixture.

19. The method as claimed in claim 16, further comprising coating the nanoparticle formulation with at least one coating agent.

20. The method as claimed in claim 16, wherein the vehicle is water, and wherein the solvent is acetone, and wherein the surfactant is polysorbate 80.

21. The method as claimed in claim 16, wherein contacting the first mixture and at least one surfactant is done at a speed in the range of 500-600 rpm, and wherein emulsifying the third mixture is done by using ultra sonification to obtain the emulsified mixture, and wherein adding the solution of nanoparticles drop-wise at a speed in the range of 850-1000 rpm to the emulsified mixture, and wherein processing the crosslinked nanoparticle is done at a speed in the range of 10,000-12,000 rpm.
